(19) United States
(12) Patent Application Publication
(10) Pub. No.: US 2026/0161336 A1
(43) Pub. Date: Jun. 11, 2026

(54) COMPUTER-READABLE STORAGE MEDIUM STORING PROGRAM FOR CAUSING A COMPUTER OF AN INFORMATION PROCESSING APPARATUS TO EXECUTE PROCESSING, INFORMATION PROCESSING APPARATUS, AND METHOD OF CONTROLLING INFORMATION PROCESSING APPARATUS

(71) Applicant: CANON KABUSHIKI KAISHA, Tokyo (JP)

(72) Inventor: YUKIHIRO NARITA, Tokyo (JP)

(21) Appl. No.: 19/410,590

(22) Filed: Dec. 5, 2025

(30) Foreign Application Priority Data
Dec. 6, 2024 (JP) 2024-213837

(51) Int. Cl. G06F 3/12

(52) U.S. Cl. CPC G06F 3/1253; G06F 3/1205

(57) ABSTRACT

A storage medium storing a program configured to cause an information processing apparatus to: obtain first information representing a size of a printing medium mounted in each of a plurality of paper feed units in a printing apparatus; obtain second information representing a size of a print target page included in print data for causing the printing apparatus to execute printing; select from among the plurality of paper feed units, based on the obtained first information and the obtained second information, a paper feed unit holding a printing medium for which a difference between the size of the printing medium and the size of the print target page satisfies a first condition; and in a case where deletion of a margin of the print target page is set, execute control to perform selection of the paper feed unit before processing of deleting the margin of the print target page.

### BACKGROUND

### Field of the Technology

The present disclosure relates to a computer-readable storage medium storing a program, an information processing apparatus, and a method of controlling the information processing apparatus.

### Description of the Related Art

When efficiently executing a plurality of print jobs using job submission software, there is a need to easily print a plurality of print files as a whole using output sheets of different sizes. For example, a large-format printer needs to efficiently print various output products such as a drawing, a poster, and a photograph on roll paper. There is a known technique of printing by a printing apparatus capable of feeding sheets from a plurality of paper feed ports. Japanese Patent Laid-Open No. 2022-73030 has disclosed a method of including, in a print job, a command for an apparatus to automatically select a paper feed port.

### SUMMARY

The present disclosure provides a technique for selecting a proper paper feed unit when using a printing apparatus including a plurality of paper feed units and when performing margin deletion processing on print data.

The present disclosure provides a non-transitory computer-readable storage medium storing a program configured to cause a computer of an information processing apparatus to function as: a first obtaining unit configured to obtain first information representing a size of a printing medium mounted in each of a plurality of paper feed units in a printing apparatus capable of feeding paper from the plurality of paper feed units; a second obtaining unit configured to obtain second information representing a size of a print target page included in print data for causing the printing apparatus to execute printing; a first selection unit configured to select from among the plurality of paper feed units, based on the first information obtained by the first obtaining unit and the second information obtained by the second obtaining unit, a paper feed unit holding a printing medium for which a difference between the size of the printing medium and the size of the print target page satisfies a first condition; and a control unit configured to, in a case where deletion of a margin of the print target page is set, execute control to perform selection of the paper feed unit by the first selection unit before processing of deleting the margin of the print target page.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram showing the hardware configuration of a printing system;

FIGS. 2A to 2D illustrate examples of screens displayed by a printing application;

FIG. 3 illustrates a table holding print setting information;

FIG. 4 illustrates a paper feed unit list displayed within a paper feed setting portion;

FIG. 5 is an illustration for explaining a calculation to select a paper feed unit;

FIG. 6 is a flowchart showing processing executed by the printing application;

FIGS. 7A and 7B are flowcharts showing processing executed by the printing application;

FIG. 8 is a diagram for explaining a print area; and

FIG. 9 is a flowchart showing processing executed by the printing application.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

Processing is sometimes performed to delete a margin from a print page when generating a print job. Upon the margin deletion processing, the print sizes of respective pages may differ. In a case where the print sizes of respective pages are different, printing may be performed in a state in which part of a print page is lost depending on a page serving as a reference for automatically selecting a paper feed unit. To prevent this, there is a need for a technique capable of selecting a proper paper feed unit when using a printing apparatus including a plurality of paper feed units and performing margin deletion processing on print data.

### First Embodiment

### <System Configuration>

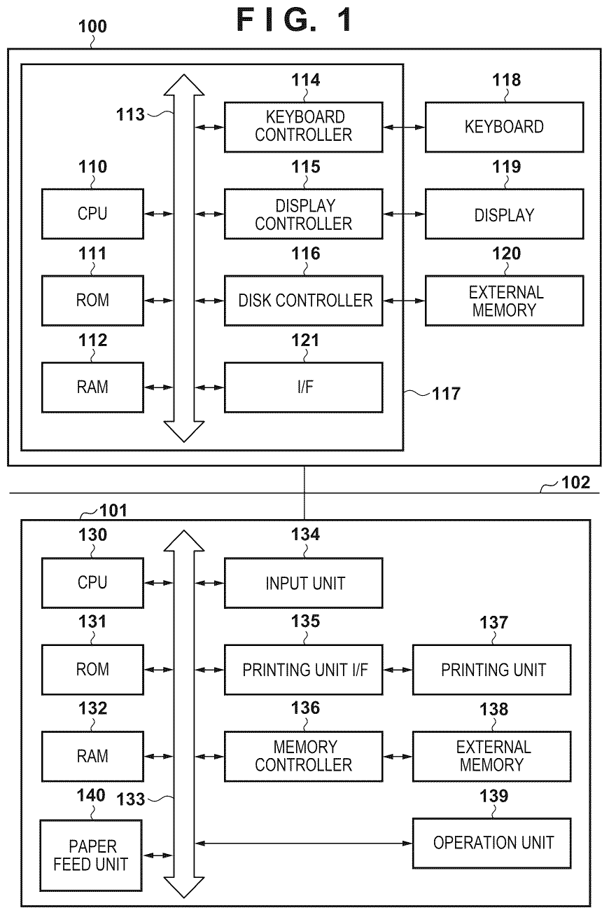

First, the configuration of a printing system according to a first embodiment will be explained. FIG. 1 is a block diagram showing an example of the hardware configurations of respective apparatuses constituting the printing system. The printing system according to this embodiment is constituted by a PC 100 serving as an information processing apparatus in which a printing application program is installed, and a printing apparatus (image forming apparatus) 101. The PC 100 and the printing apparatus 101 are connected via bus communication or network communication such as a wireless Local Area Network (LAN), a wired LAN, near field communication, or a USB. Note that the printing application program is sometimes called job submission software or a printing application. Note that the printing system includes one printing apparatus 101 in this embodiment, but the number of printing apparatuses 101 in the printing system is not limited to one and may be two or more. Similarly, the number of PCs 100 in this embodiment is also one, but may be two or more. If the functions of the PC 100 are incorporated in the printing apparatus 101, the printing system may be constituted by only the printing apparatus 101.

The PC 100 will be explained as an example of the information processing apparatus in this embodiment, but the information processing apparatus is not limited to this and various devices are applicable, including a mobile terminal, a tablet terminal, a Personal Digital Assistant (PDA), or a digital camera. The printing apparatus 101 is, for example, a printer. When the printing apparatus 101 is, for example, a printer, it can be an inkjet printer, a full-color laser beam printer, a monochrome printer, or the like. In addition, the printing apparatus 101 can be a multi-function peripheral having a plurality of functions such as a copy function, a FAX function, a print function, and a scanner function.

First, the printing apparatus 101 will be explained. The printing apparatus 101 is controlled by a CPU 130. The CPU 130 is also called a processor or a controller. The CPU 130 operates based on a program stored in a ROM 131, a program stored in an external memory 138, or the like. These programs include a printing application. The CPU 130 outputs an image signal as output information to a printing unit 137 connected to a printing unit interface (I/F) 135 via a system bus 133.

The printing apparatus 101 includes a paper feed unit 140. In the paper feed unit 140, printing media are mounted. A printing medium in the paper feed unit 140 is fed into the printing apparatus 101 by a feeding unit (not shown), and an image is recorded (printed) on it by the printing unit 137 (to be described later). Note that “printing” not only includes the formation of information such as characters and graphics, regardless of whether they are significant or insignificant. “Printing” also broadly includes the formation of images, figures, patterns, and the like on a printing medium, or the processing of the medium, regardless of whether they are so visualized as to be visually perceivable by humans. In this embodiment, roll paper will be exemplified as a printing medium, but the printing medium may be cloth, a plastic film, or the like. For example, not only a roll printing medium but also a bundle of printing media may be mounted in the paper feed unit 140. In this example, only one paper feed unit 140 is illustrated, but the printing apparatus 101 includes a plurality of paper feed units 140. In the respective paper feed units 140, printing media of different sizes (widths) may be mounted, or printing media of the same size may be mounted.

The CPU 130 can perform communication processing with the PC 100 via an input unit 134, and can notify (transmit) the PC 100 of information in the printing apparatus 101. The CPU 130 can receive output data or the like for the printing unit 137 from the PC 100 via the input unit 134.

Note that the input unit 134 may be a communication I/F (that is, a communication unit) such as a LAN, and is connected to a communication network 102, which also connects the PC 100. The input unit 134 sometimes outputs a signal to a communication partner such as the PC 100.

A RAM 132 is a memory functioning as the main memory, work area, and the like of the CPU 130, and is constituted so that the memory capacity can be expanded by an optional RAM connected to an expansion port (not shown). Note that the RAM 132 is used for an output information deploying area, an environmental data storage area, a nonvolatile memory, and the like.

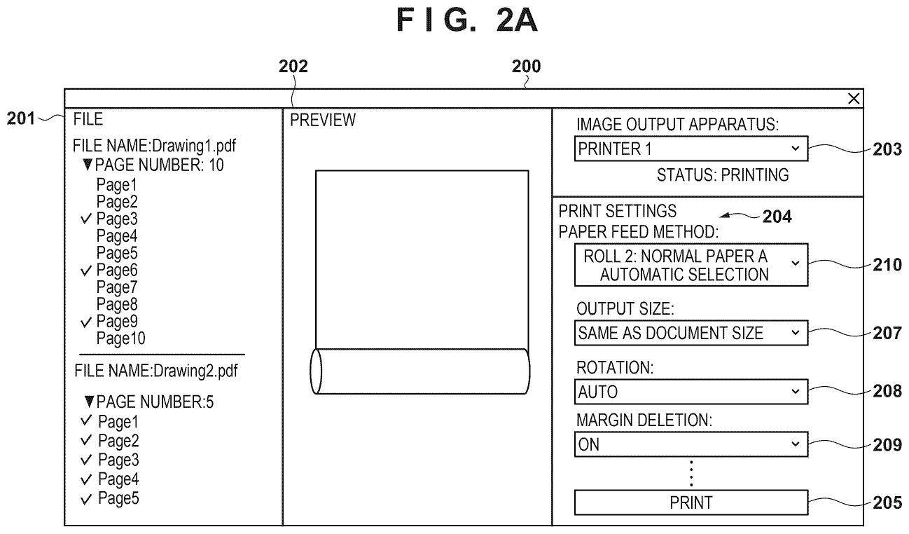

Access to the external memory 138 such as a hard disk (HDD) or an IC card is controlled by a memory controller 136. The external memory 138 can be connected as an option, and stores font data, an emulation program, form data, information about paper registered in the printing apparatus 101, and the like. The information about paper includes, for example, information representing the paper size, paper attribute information (information representing the paper type), and the like. The information representing the paper size is, for example, information representing the width and height of the paper. An operation unit 139 includes an operation panel, can display various kinds of information such as a user interface screen shown in FIG. 2A, and accepts an input by a user.

Next, the PC 100 will be explained. A computer 117 inside the PC 100 includes a CPU 110, a ROM 111, a RAM 112, a keyboard controller 114, a display controller 115, a disk controller 116, and a communication I/F 121.

The CPU 110 may read out a control program and the like from the ROM 111. The CPU 110 may be a dedicated circuit such as an ASIC. The CPU 110 executes each process, control, and the like (to be described later) by deploying in the RAM 112 a printing application program stored in the memory such as the ROM 111, and executing it. The CPU 110, which may be implemented as a dedicated circuit, is an example of a hardware circuit or hardware processor. Similar to the CPU 130, the CPU 110 is sometimes called a processor or a controller.

The disk controller 116 controls access to an external memory 120 such as an HDD, a CD-ROM, a DVD-ROM, or a USB flash drive. The RAM 112 is constituted so that its capacity can be expanded by an optional RAM (not shown) or the like. The RAM 112 is mainly used as the work area of the CPU 110.

The keyboard controller 114 controls a key input from a keyboard 118 or input from a pointing device (not shown). The display controller 115 controls display on a display 119. The communication I/F 121 is connected to the communication network 102, and controls communication with an external apparatus with which it can communicate. Note that in this embodiment, the CPU 110 controls each unit connected to a main bus 113 via the main bus 113, unless otherwise specified.

### <Display Screen and Print Settings by Printing Application>

FIG. 2A illustrates an example of a main screen 200 displayed on the display 119 when a printing application installed in the PC 100 is executed. A main screen 200 displays a file display portion 201, a preview display portion 202, an apparatus designation portion 203, a print setting portion 204, a print execution button 205, and the like.

Within the file display portion 201, information about a file to be printed (to be referred to as a print target file) is displayed. The information about a print target file includes a file name, information (for example, page count) representing the configuration of pages included in the print target file, and the like. Within the file display portion 201, a plurality of print target files are displayed, as shown in FIG. 2A. Within the file display portion 201, a file name, information representing the configuration of pages included in each print target file, and the like are displayed so that a user selection can be accepted. Note that a print target file is, in other words, an output data file (print data file) that is to be output to the printing apparatus 101 for printing. Each print target file may be selected by the user designating a file name within the file display portion 201. A print target file may be selected by, for example, displaying the file names of files stored in a predetermined folder as candidates by pop-up or the like, and selecting a print target file from among them.

The preview display portion 202 displays a preview of the print layout of each page of a print target file selected via the file display portion 201. That is, a print target page included in a print target file selected by the user is displayed within the preview display portion 202. In the print target page, data corresponding an image of an original, an image, and the like are arranged.

The apparatus designation portion 203 is an item (pulldown list) capable of accepting a user selection of a printing apparatus 101 serving as a print job transmission destination. The apparatus designation portion 203 displays the name of a printing apparatus 101 for which a user selection is accepted.

The print setting portion 204 displays, for example, various items regarding print settings. The user can select print settings from various print setting items (pulldown lists) displayed within the print setting portion 204. The print setting portion 204 includes a paper feed setting portion 210, an output size designation portion 207, a rotation designation portion 208, a margin deletion designation portion 209, and the like. Note that the apparatus designation portion 203 may be included within the print setting portion 204.

The paper feed setting portion 210 is an item capable of accepting a user selection of a paper feed method of a printing apparatus 101. The paper feed setting portion 210 displays the name of the paper feed method.

The output size designation portion 207 is an item capable of accepting a user selection of an output size for printing. FIG. 2B illustrates an example of a pulldown list of selectable output size options displayed within the output size designation portion 207. As shown in FIG. 2B, the output size designation portion 207 displays a list (selection items) of settable output sizes.

The rotation designation portion 208 is an item capable of accepting a setting regarding processing for rotating the print area of an image for printing. FIG. 2C illustrates an example of a pulldown list of selectable rotation processing options displayed within the rotation designation portion 208. As shown in FIG. 2C, the rotation designation portion 208 displays a list (selection items) of settable rotation processes. The rotation designation portion 208 includes, for example, an item for rotating a print area by 90° with respect to the output direction, an item for rotating a print area by 180°, and the like.

The margin deletion designation portion 209 is an item capable of accepting a user selection of whether to execute processing for deleting an unnecessary margin of a printed product. FIG. 2D illustrates an example of a pulldown list of selectable margin deletion options displayed within the margin deletion designation portion 209. As shown in FIG. 2D, the margin deletion designation portion 209 includes an item for activating the margin deletion setting, and an item for deactivating the margin deletion setting. When the margin deletion setting is activated within the margin deletion designation portion 209, the CPU 110 executes processing for deleting an unnecessary margin in a print target page when creating a print job. In contrast, when the margin deletion setting is deactivated, the CPU 110 does not execute the processing for deleting an unnecessary margin in a print target page when creating a print job.

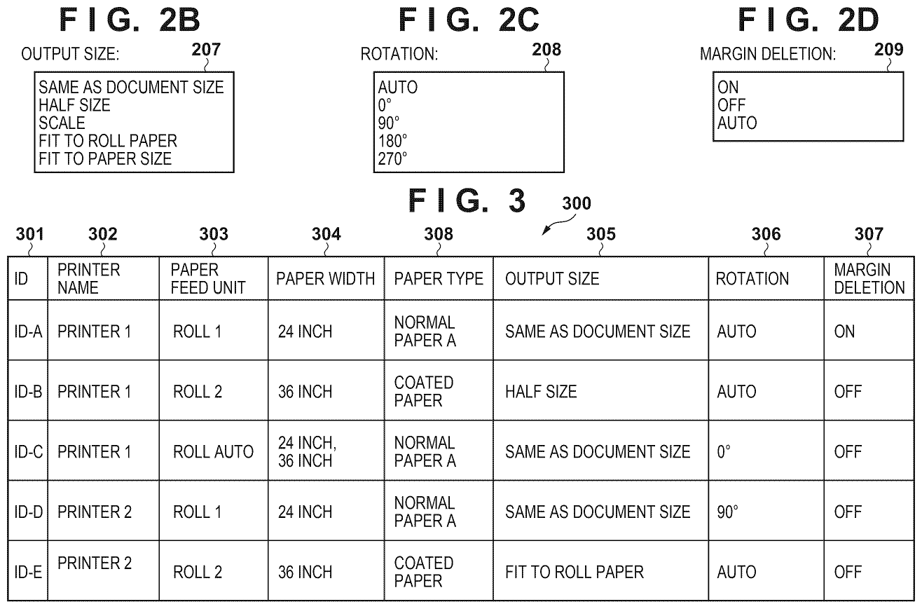

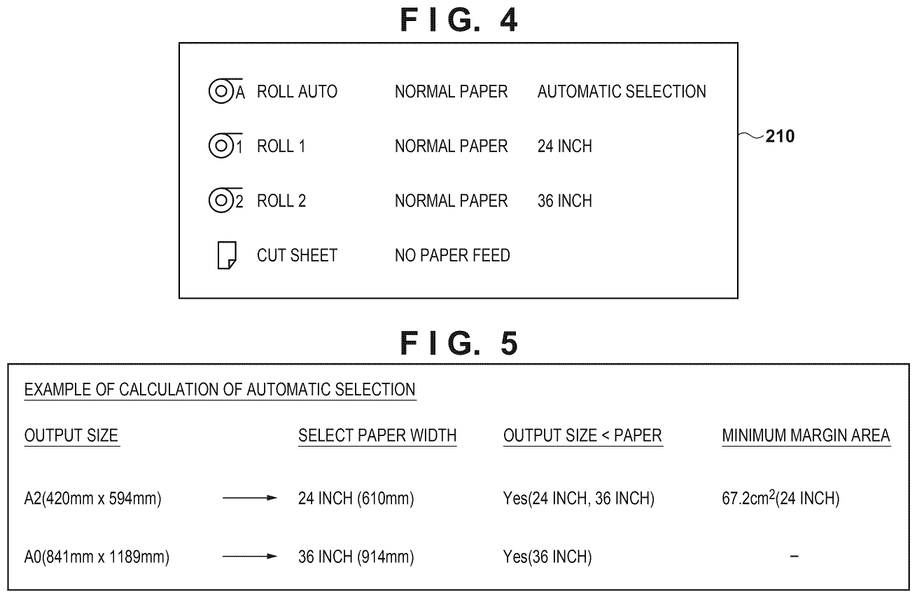

When the CPU 110 accepts user operations for various print setting items of the apparatus designation portion 203 and the print setting portion 204, it executes control to store content (print setting information) set (selected) within the respective setting items in memory such as the RAM 112. Note that details of this will be explained with reference to FIG. 3 (to be described later). The print setting information stored in the memory is referred to in processing related to FIG. 4 (to be described later) and the like. Note that, in addition, when the print button 205 (to be described later) is pressed, the CPU 110 may execute control to store the print setting information in memory such as the RAM 112.

When the CPU 110 accepts user operations for various print setting items within the print setting portion 204, it displays within the preview display portion 202 a print preview to which set (selected) print settings are applied. Within the preview display portion 202, one or a plurality of print target pages are simultaneously displayed, and if there are more print target pages than can be displayed simultaneously, a preview can be displayed with a next page button or a previous page button (neither is shown). In this manner, the user can confirm a print preview corresponding to print settings before the printing apparatus 101 executes printing. This can suppress a print failure.

The print button 205 is a button capable of accepting a user instruction to start printing. When the print button 205 is pressed (clicked or tapped), the CPU 110 creates a print job including print setting information from a print target file based on print settings designated within the print setting portion 204. The CPU 110 transmits the created print job to the printing apparatus 101.

In this embodiment, the CPU 110 arranges a print area using the upper and left sides as a reference for each print target page based on various print settings accepted on the main screen 200. The upper side is a side serving as the paper conveyance direction side when the printing apparatus 101 prints, and the left side is a side left perpendicular to the upper side.

Note that a print area obtained by eliminating a margin from a print target page is arranged on paper so that the upper and left sides of the print area become collinear with the upper and left sides of the paper.

Note that arranging a print area is determining the layout of a print target page on paper. After determining the layout of a print target page, for example, the result is displayed within the preview display portion 202. The finally determined arrangements and print settings of print target pages are included as information in a print job generated by the printing application, and the print job is transmitted to the printing apparatus 101. The respective print target pages are printed in accordance with the print settings, as arranged by the printing application.

FIG. 3 illustrates an example of a table 300 in which print setting information stored in memory such as the RAM 112 is registered (held). For example, when the print button 205 is pressed on the main screen 200, the CPU 110 registers, in the table 300, print setting information based on user operations on the main screen 200. FIG. 3 exemplifies print setting information for a plurality of jobs, but print setting information is created in accordance with one print instruction for one job. For example, every time the print button 205 is pressed, print setting information of one job is additionally registered in the table 300.

As setting items, the table 300 includes an ID 301, a printer name 302, a paper feed unit 303, a paper width 304 representing the width of paper mounted in the paper feed unit 140, a paper type 308, an output size 305, rotation 306, margin deletion 307, and the like. In the table 300, other print setting information may be added to the print setting information shown in FIG. 3, or part of the print setting information shown in FIG. 3 may be omitted. For example, the name of a print target file may be included as a setting item of the table 300. That is, the name of a print target file may be registered in the table 300 in linkage with identification information of a print job. A form in which all pieces of print setting information are managed in one table 300 has been described here, but a separate table for each setting value regarding a specific setting item (for example, a table corresponding to printer 1 and a table corresponding to printer 2) may be prepared.

Identification information of a print job is registered in the column of the ID 301 among the setting items. The name of a printer set within the apparatus designation portion 203 is registered in the column of the printer name 302 among the setting items. That is, information representing a printing apparatus 101 serving as the output designation (transmission destination) of a print job is registered in the column of the printer name 302. A paper feed method set within the paper feed setting portion 210 is registered in the respective columns of the paper feed unit 303, paper width 304, and paper type 308. Values set within the respective setting items of the output size designation portion 207, rotation designation portion 208, and margin deletion designation portion 209 represented within the print setting portion 204 are registered in the respective columns of the output size 305, rotation 306, and margin deletion 307. For example, a value set within the rotation designation portion 208 is registered in the column of the rotation 306. For example, a setting of “auto” for properly rotating a print area by the printing application, or a rotation angle designated by the user, is registered in the column of the rotation 306. Note that a rotation angle permitted in rotation processing (that is, a settable rotation angle) may be only either 0° or 90°, or a multiple of 90° may be registered. A value set within the margin deletion designation portion 209 is registered in the column of the margin deletion 307. More specifically, either “ON” (to perform margin deletion processing) or “OFF” (not to perform margin deletion processing) is registered in the column of the margin deletion setting 307.

A setting value such as “roll auto” representing automatic selection of the paper feed unit 140 in accordance with processing of the printing application can also be registered in the column of the paper feed unit 303. When “roll auto” is registered in the column of the paper feed unit 303, a plurality of candidate values that can change based on “roll auto” can also be registered in the corresponding column of the paper width 304. In the example of FIG. 3, a plurality of setting values are registered in only the column of the paper width 304. However, it is also possible to register a single setting value in the column of the paper width 304, and register a plurality of setting values in the column of the paper type 308.

In this fashion, various kinds of print setting information such as the paper width, the output size, rotation of an image, and margin deletion are registered in the table 300 for each print job.

FIG. 4 illustrates an example of a paper feed unit list displayed within the paper feed setting portion 210. A paper feed unit list capable of accepting a user selection is displayed within the paper feed setting portion 210. As the paper feed unit list, the paper feed setting portion 210 displays, for example, information such as a setting name regarding each paper feed unit 140 of the printing apparatus 101, the type of paper mounted in each paper feed unit 140, and the width of the paper.

In the example of FIG. 4, for example, roll 1, roll 2, and cut sheet are the setting names of the respective paper feed units 140 of the printing apparatus 101. In the example of FIG. 4, “roll auto” is a setting name for automatically selecting the paper feed unit 140 from among the respective paper feed units 140 of the printing apparatus 101 when printing. In the example of FIG. 4, “roll auto” represents that the paper feed unit 140 of either roll 1 or roll 2 of the same paper type is selectable. When “roll auto” is selected within the paper feed setting portion 210, the CPU 110 selects either roll 1 or roll 2 as the paper feed unit 140 used for printing in accordance with the size of a print target page. Note that when no paper is mounted in the paper feed unit 140, the paper feed setting portion 210 displays a message representing that no paper is mounted. In the example of FIG. 4, “Cut Sheet” represents that no paper is mounted in the paper feed unit 140 of cut sheet.

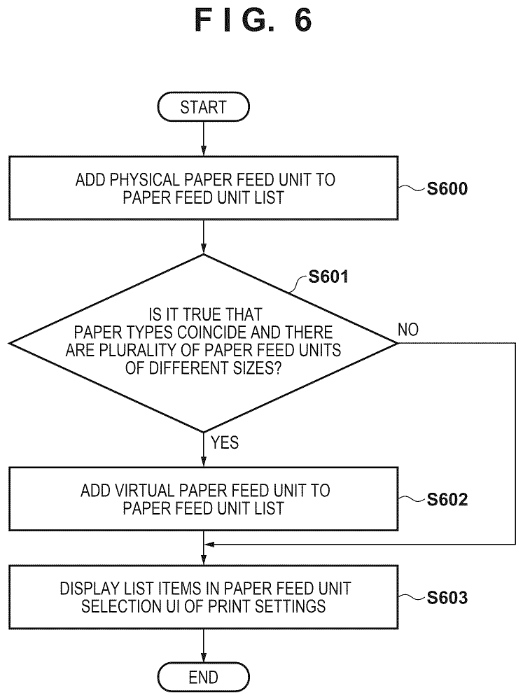

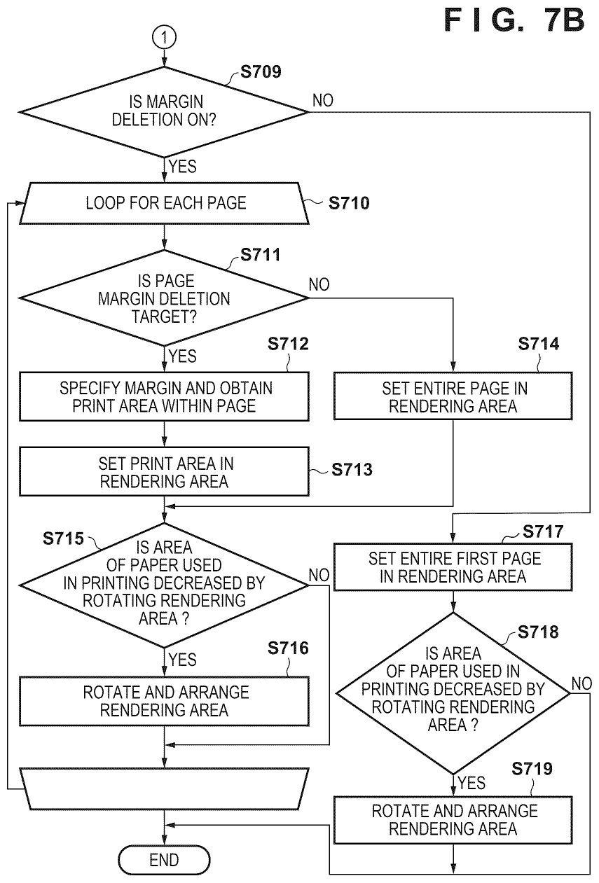

FIG. 5 is an illustration for explaining processing of the CPU 110 when “roll auto” is selected within the paper feed setting portion 210. When “roll auto” is selected within the paper feed setting portion 210, the CPU 110 executes processing for selecting the paper feed unit 140 suited to the output size of a print target page. Details of this processing will be described later with reference to FIGS. 7A and 7B.

First, the CPU 110 checks whether the output size of a print target page is smaller than the width of the paper mounted in each paper feed unit 140. More specifically, the CPU 110 calculates, based on information representing the width of the paper mounted in each paper feed unit 140 usable for “roll auto,” whether part of a printed product would be lost in printing the print target page. Then, the CPU 110 holds the result.

When there are a plurality of paper widths larger than the output size, the CPU 110 calculates margin areas for the respective paper widths. The CPU 110 selects the paper feed unit 140 corresponding to, of these paper widths, the paper width having the minimum margin area.

Note that when calculating the presence/absence of loss of a print target page or a minimum margin area, the CPU 110 may calculate it in consideration of a case where the print target page is rotated. For example, the CPU 110 calculates, based on information representing the width of the paper mounted in each paper feed unit 140 usable for “roll auto,” whether part of a printed product is lost in at least either a case where a print target page is rotated or a case where it is not rotated. Then, the CPU 110 may hold the result. If the CPU 110 determines that there is no loss in the printed product in either the case where the print target page is rotated or the case where it is not rotated, it may calculate minimum margin areas for paper widths at each of which it is determined that there is no loss in the print target page. Then, the CPU 110 may select the paper feed unit 140 corresponding to, of these paper widths, the paper width having the minimum margin area.

As an example, when the output size is A2 (420 mm wide and 594 mm high), as shown in FIG. 5, there is no loss in a print target page (print data) for both roll 1 (24 inches/610 mm wide) and roll 2 (36 inches/914 mm wide). Thus, the CPU 110 calculates minimum margin areas for both of the rolls. In a case where the output size is A2, when printing the print target page on roll 1 and roll 2, the margin is decreased by rotating the print target page by 90°. Therefore, margin areas are calculated in a state in which the print target page is rotated by 90°. The margin area of roll 1 is calculated to be 420 mm×(610 mm−594 mm)=6720mm² . The margin area of roll 2 is calculated to be 420 mm×(914 mm−594 mm)=134400mm² . Since the margin area of roll 1 is the minimum, the CPU 110 selects roll 1. As another example, in a case where the output size is A0 (841 mm wide and 1189 mm high), the CPU 110 similarly checks whether there is loss in the print target page, and determines that the paper feed unit 140 resulting in no loss of the print data is only roll 2. In such a case, the CPU 110 selects roll 2 as the output destination paper feed unit 140 without calculating a minimum margin area.

### <Processing Executed by Printing Application>

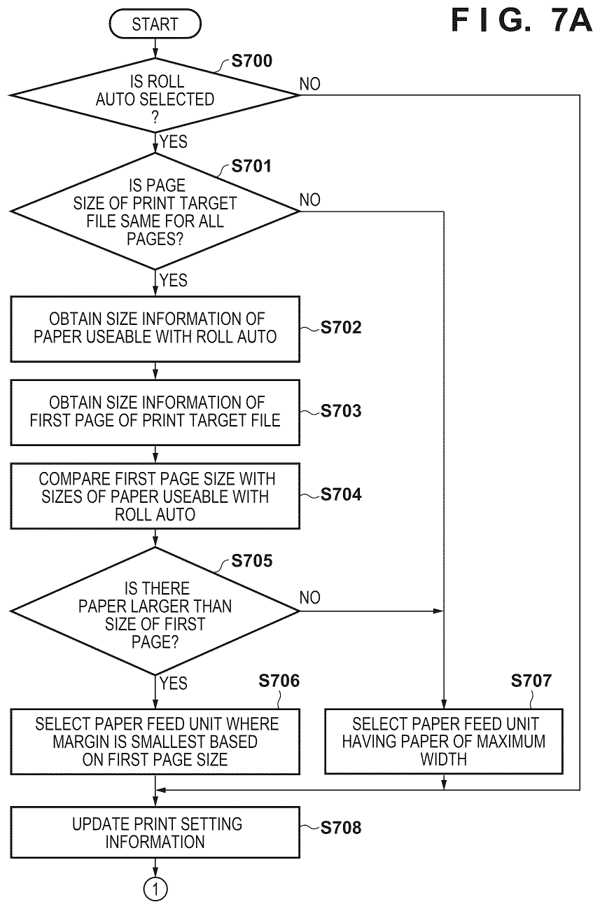

FIG. 6 is a flowchart showing an example of a sequence of creating a paper feed unit list displayed within the paper feed setting portion 210 of the main screen 200. This sequence starts at a timing when the printing apparatus 101 is changed within the apparatus designation portion 203, or when the CPU 110 detects that paper information of the paper feed unit 140 has been changed. Note that the processing in FIG. 6 is implemented by, for example, the CPU 110 deploying in the RAM 112 a printing application program stored in memory such as the ROM 111, and executing it.

Note that a change of the paper information is detected by the CPU 110 periodically obtaining status information from the printing apparatus 101 in accordance with the printing application. For example, the CPU 110 makes an inquiry to printing apparatus 101 every time a predetermined time (for example, 1 sec) elapses. That is, the CPU 110 requests status information from the printing apparatus 101. When the printing apparatus 101 receives the status information request, it transmits to the PC 100 status information including information about the paper feed units 140. The information about the paper feed units 140 includes, for example, information (information representing the paper size and information representing the paper type) about the paper mounted in each paper feed unit 140. The CPU 110 compares paper information obtained in the past from the printing apparatus 101 with the currently obtained paper information. If different paper information is included, the CPU 110 determines that the paper information has been changed, and starts the following processing.

In step S600, the CPU 110 adds a physical paper feed unit to the paper feed unit list stored in the ROM 111 or the RAM 112. For example, the CPU 110 stores, in memory such as the ROM 111, a setting value for individually displaying a user-selectable item of a paper feed unit 140 within the paper feed setting portion 210. With reference to FIG. 4 as an example, the CPU 110 performs a process for adding roll 1, roll 2, and cut sheet to the paper feed unit list.

In step S601, the CPU 110 determines whether a combination of the paper feed units 140 whose paper types coincide with each other and whose paper sizes are different exists among the paper feed units 140. If the CPU 110 determines that there is such a combination, it advances to step S602. If the CPU 110 determines that there is no such combination, it advances to step S603.

In step S602, the CPU 110 adds a virtual paper feed unit to the paper feed unit list stored in the ROM 111 or the RAM 112. For example, the CPU 110 stores, in memory such as the ROM 111, a setting value for displaying within the paper feed setting portion 210 a setting item (roll auto) for accepting automatic selection of the paper feed unit 140. Further, the CPU 110 updates the table 300 stored in memory such as the ROM 111. More specifically, the CPU 110 registers “roll auto” in the column of the paper feed unit 303, and registers paper width setting values (24 inches and 36 inches in the example of FIG. 4) in the corresponding column of the paper width 304 and paper type setting values in the column of the paper type 308.

In step S603, the CPU 110 retrieves from memory such as the ROM 111 and displays, within the paper feed setting portion 210, a paper feed unit list corresponding to the paper feed units 140 of the printing apparatus 101 designated within the apparatus designation portion 203.

FIGS. 7A and 7B are flowcharts showing an example of processing executed by the printing application. The processing in FIGS. 7A and 7B is implemented by, for example, the CPU 110 deploying in the RAM 112 a printing application program stored in the memory such as the ROM 111, and executing it. In FIGS. 7A and 7B, processing of executing the printing application by the CPU 110 to select the paper feed unit 140 and set a print area will be explained. The CPU 110 starts the processing in FIG. 7A based on a press of the print button 205. Also, the CPU 110 starts the processing at a timing to start creation of a print job or a timing to update (render again) the display of the preview display portion 202. The timing to update the preview display portion 202 is, for example, a timing when any setting within the print setting portion 204, which influences the preview, has been changed.

In step S700, the CPU 110 determines whether a print target file is one for which the setting value of the paper feed unit 303 is set to be “roll auto.” That is, in step S700, the CPU 110 determines whether “roll auto” is selected within the paper feed setting portion 210. If the CPU 110 determines that a print target file is one for which the setting value of the paper feed unit 303 is set to be “roll auto,” it advances to step S701. If YES is determined in step S700, processing of selecting the paper feed unit 140 of a size suited to the size of a print target page included in the print target file is necessary, so the CPU 110 advances to processing in step S701 and subsequent steps. If the CPU 110 determines that a print target file is not one for which the setting value of the paper feed unit 303 is set to be “roll auto,” it advances to step S708. If NO is determined in step S700, the CPU 110 advances to step S708 to update the print setting information so that the setting value of the paper feed unit 303 is set to be the paper feed unit 140 designated within the paper feed setting portion 210, which is the paper feed unit 140 to be used for printing.

In step S701, the CPU 110 determines whether the page size of the print target file is the same for all print target pages. If the CPU 110 determines that the page size of the print target file is the same for all print target pages, it advances to step S702. To the contrary, if the CPU 110 determines that the page size of the print target file is not the same for all print target pages, it advances to step S707. More specifically, the CPU 110 obtains pieces of information (for example, header information) representing the page sizes of all the print target pages included in the print target file. Then, the CPU 110 compares, for example, the pieces of information representing the page sizes of all the print target pages. The CPU 110 determines, for example, whether the comparison results coincide with each other.

In step S702, the CPU 110 obtains information representing the size of the paper mounted in each paper feed unit 140 assigned to be useable with “roll auto.” More specifically, the CPU 110 looks up the table 300 stored in memory such as the RAM 112 and obtains the setting value of a paper width corresponding to the setting value of “roll auto.” In the example of FIG. 4, the CPU 110 obtains 24 inches and 36 inches registered in the column of the paper width 304.

In step S703, the CPU 110 obtains information representing the size (width and height) of the first page of the print target file.

In step S704, the CPU 110 compares the size (width and height) of the first page of the print target file obtained in step S703 with the size (paper width) of each paper obtained in step S702.

In step S705, the CPU 110 determines, with reference to the comparison result in step S704, whether the size of any paper obtained in step S702 is larger than that of the first page of the print target file. If the CPU 110 determines that the size of any paper is larger, it advances to step S706. If the CPU 110 determines that the size of each paper is not larger, it advances to step S707.

More specifically, in step S705, the CPU 110 determines whether the width of any paper obtained in step S702 is larger than the width or height of the first page. That is, the CPU 110 determines whether there is a paper feed unit 140 holding paper on which the first page fits in a case where the first page is not rotated or in a case where the first page is rotated by 90°. Note that in step S705, when the first page is set not to rotate within the rotation designation portion 208, the CPU 110 determines whether the width of any paper obtained in step S702 is larger than that of the first page.

Note that in this embodiment, the CPU 110 obtains information representing the size of the first page in step S703, but the processing is not limited to this. In step S703, the CPU 110 may obtain information representing the sizes of pages other than the first page of the print target file. The CPU 110 may perform processes in step S704 to step S706 by using information representing the sizes of pages other than 74 the first page.

If there are paper feed units 140 each holding paper of a width on which the print target page can be printed without any loss, in step S706, the CPU 110 selects, from the paper feed units 140, the paper feed unit 140 holding paper of a width at which the margin of a printed product is smallest.

That is, in step S706, the CPU 110 selects the paper feed unit 140 holding paper for which the difference between the size of the paper mounted in the paper feed unit 140 and that of the print target page satisfies a first condition. The first condition includes a condition that the size of the paper is larger than that of the print target page. Also, the first condition includes a condition that the difference between the size of the paper and that of the print target page is minimum. By selecting the paper feed unit 140 holding paper that satisfies the first condition, the print target page can be printed without any loss and without generating an unnecessary margin in a printed product.

In step S707, loss may occur in the print target page regardless of which paper feed unit 140 is selected, so the CPU 110 selects the paper feed unit 140 holding paper of a maximum size (width) so as to minimize the amount of loss.

In step S708, the CPU 110 updates (sets) the print setting information by setting the paper feed unit 140 selected in step S706 or step S707 as the paper feed unit used in printing. In other words, the paper feed unit used in printing is an output destination paper feed unit.

In step S709, the CPU 110 determines whether the margin deletion setting is ON for the print target file. If the CPU 110 determines that the margin deletion setting is ON, it advances to step S710. If the CPU 110 determines that the margin deletion setting is OFF, it advances to step S717.

Processing in step S710 through step S716 is performed for each page included in the print target file. In this embodiment, a print job is linked to one print target file by, for example, an identification number, and the print target file includes print data of one or a plurality of print target pages. Note that print data of one page may be one file, and one or a plurality of files may constitute one job. The processing in step S710 through step S716 of FIGS. 7A and 7B is repeated until, for a print target file selected within the file display portion 201, the CPU 110 finishes processing the print target pages selected in the file. When a print target file is selected and execution of printing is designated, the print setting portion 204 in FIG. 2A, for example, the output size designation portion 207, the rotation designation portion 208, the margin deletion designation portion 209, and the like, are referred to.

In step S711, the CPU 110 determines whether the page of interest is a margin deletion target. If the CPU 110 determines that the page of interest is a margin deletion target, it advances to step S712. If the CPU 110 determines that the page of interest is not a margin deletion target, it advances to step S714. A margin to be deleted is a blank area around a print area (rendering area) in which a character or an image graphic is rendered. For example, in step S711, when the file format of the page of interest is a drawing file (drawing data), the CPU 110 can determine that no margin is necessary for the drawing, and determines that the page of interest is a margin deletion target. To the contrary, when the file format of the page of interest is an image data file, a photograph or graphic art in the page of interest can be rendered in the print area. Hence, even if there is a margin, it is not always appropriate to regard the margin as a deletion target. When the file format of the page of interest is an image data file, the CPU 110 determines that the page of interest is not a margin deletion target. This is because the work of a photograph or graphic art is sometimes composed to include even a margin.

A drawing file has, for example, a file format often used in drawing output. A drawing file is of a format such as, for example, a PDF file, a HPGL/2 file, or a save file of another drawing output application. An image data file is of a file format used to save image data such as JPEG or TIFF or to save output data of another graphic production application.

The file format of a page of interest can be specified by a file name (for example, extension). The CPU 110 makes the determination in step S711 based on, for example, a file name. Note that the CPU 110 may determine which of a drawing file and an image file is the print target file, and if the print target file is neither a drawing file nor an image file, determine that the print target file is another file. As the determination criterion in step S711, a method other than the above-described determination may be used.

Note that when “auto” is registered in the margin deletion 307 of the table 300, the CPU 110 may execute the above-described determination. When “ON” is registered in the margin deletion 307, the CPU 110 may determine to always perform margin deletion (YES in step S711).

Note that as for a file format such as PDF, one print target file may include a plurality of pages. For such a file composition, the CPU 110 may determine the type of file (file format) including a page of interest in step S711. For example, in FIG. 2A, assume that the print target file is a PDF file, “Drawing1.pdf,” and includes first through 10th print target pages. In such a case, in step S711, the CPU 110 may determine, based on the file name of the print target file, whether each page included in the print target file is a margin deletion target.

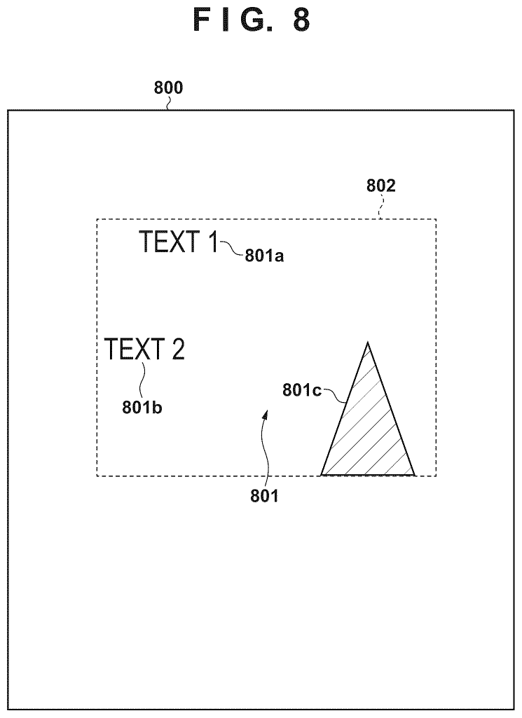

In step S712, the CPU 110 obtains the size of a print area from the print data of the page of interest. More specifically, the CPU 110 obtains the size of a print area by excluding the margin area from the print data of the page of interest. Here, FIG. 8 will be referred to. FIG. 8 is a diagram for explaining a print area. A print area 802 is a rectangular area surrounding a rendering object 801 in print data 800. The rendering object 801 includes, for example, a text object 801a, a text object 801b, a graphic object 801c, and the like, as shown in FIG. 8. Note that FIG. 8 shows an example in which the rendering object 801 includes both text and graphic objects, but a rendering object may only include one type of object. The CPU 110 scans from the edge of each side as for at least one of the top, bottom, left, or right sides of the print data 800, thereby obtaining the size of the print area 802 surrounding the rendering object 801. If the print data 800 is a dot image, it may be scanned line by line, for example. If the print data 800 is data that defines the position of the rendering object 801, the size of the print area 802 may be obtained from a point closest to each side based on the position and spread of the rendering object 801. In step S712, the CPU 110 specifies the outside of the print area 802 as a margin area. Since the rendering object 801 does not exist in the margin area, the margin area can be removed to save paper in printing.

In step S713, the CPU 110 sets the obtained print area as a rendering area in the page.

In step S714, the CPU 110 sets the entire page of interest in the rendering area.

In step S715, the CPU 110 determines whether the area of paper used in printing is decreased by rotating the rendering area. If the CPU 110 determines that the area of paper used is decreased, it advances to step S716. If the CPU 110 determines that the area of paper used is not decreased, it returns to step S710 if there is another page of interest after step S715. If there is no other page of interest, the CPU 110 ends the processing in FIGS. 7A and 7B. For example, when printing on roll paper, the paper is cut in accordance with the size of a printed product. As the length of the printed product in the conveyance direction is smaller, the consumption amount of paper becomes smaller. From this, the determination in step S715 is made based on the result of comparing areas of paper (areas of a sheet) used in a case where the rendering area is not rotated and a case where it is rotated by 90°. That is, in step S715, if the comparison result indicates that the paper area becomes smaller in a case where the rendering area is rotated by 90° than in a case where the rendering area is not rotated, the CPU 110 determines to rotate the rendering area. In contrast, if the comparison result indicates that the paper area becomes smaller in a case where the rendering area is not rotated than in a case where the rendering area is rotated by 90°, the CPU 110 determines not to rotate the rendering area.

Note that the paper area has been exemplified here, but margin areas outside the rendering area may be compared. Alternatively, the lengths of the height (conveyance direction) and width (widthwise direction perpendicular to the conveyance direction) of a page of interest may be compared. If the lengths in the direction perpendicular to the conveyance direction of paper is longer and print data falls within the output width after rotation, it may be determined to rotate the rendering area.

In step S716, the CPU 110 rotates by 90° the rendering area obtained by excluding the margin area from the print data, and arranges it. If there is another page of interest after step S716, the CPU 110 returns to step S710. If there is no other page of interest, the CPU 110 ends the processing in FIGS. 7A and 7B. Note that the rotation angle in step S716 may be determined in accordance with the method of postprocessing such as binding or packaging or in accordance with another criterion.

Note that the processing in step S710 through step S716 may be processing of displaying a preview of a page of interest serving as the result of processing, and when, for example, a user operation is performed to proceed to the next page, advancing the processing for the next page.

In this embodiment, the CPU 110 executes the processing in step S715 and step S716, but the processing in step S715 and step S716 may be omitted. For example, when it is set within the rotation setting 208 not to rotate the rendering area, the CPU 110 omits the processing in step S715 and step S716.

In step S717, the CPU 110 sets the entire page of interest in the rendering area.

In step S718, the CPU 110 determines whether the area of paper used in printing is decreased by rotating the rendering area. If the CPU 110 determines that the area of paper used is decreased, it advances to step S719. If the CPU 110 determines that the area of paper used is not decreased, it ends the processing in FIGS. 7A and 7B. This determination is performed similar to step S715, and a detailed description thereof will be omitted.

In step S719, the CPU 110 rotates the rendering area by 90° and arranges it. Note that the rotation angle in step S719 may be determined in accordance with the method of postprocessing such as binding or packaging or in accordance with another criterion.

In this embodiment, the CPU 110 executes the processing in step S718 and step S719, but the processing in step S718 and step S719 may be omitted. For example, when it is set within the rotation setting 208 not to rotate the rendering area, the CPU 110 omits the processing in step S718 and step S719.

Upon completion of the print settings of the print target page by the processing in FIGS. 7A and 7B, the CPU 110 displays a preview image corresponding to the print settings within the preview display portion 202. The CPU 110 stores, in memory such as the RAM 112, information of each print target page having undergone margin deletion or rotation processing.

Also, upon completion of the processing in FIGS. 7A and 7B, the CPU 110 generates a print job including the paper feed unit 140 selected in step S706 or step S707 and information of each print target page, and transmits the print job to the printing apparatus 101.

Note that the print job transmission timing is not limited to this. For example, when the print setting information is updated in step S708, the CPU 110 may generate a print job including the paper feed unit 140 selected in step S706 or step S707 and information of each print target page, and transmit the print job to the printing apparatus 101. Alternatively, for example, when the processing in step S710 through step S716 end for each page of interest, the CPU 110 may generate a print job including the paper feed unit 140 selected in step S706 or step S707 and information of each print target page, and transmit the print job to the printing apparatus 101. Even if the processing in step S710 through step S716 for each page does not end for all pages of interest, when the processing for one page ends, a print job may be transmitted to the printing apparatus 101. This can advance the margin deletion processing by the CPU 110 while executing printing by the printing apparatus 101.

When paper mounted in the paper feed unit 140 selected as the paper feed unit 140 runs out after the start of printing, the CPU 110 may receive from the printing apparatus 101 a notification that printing is interrupted. The notification that printing is interrupted may be included in, for example, the above-mentioned status information. When the CPU 110 receives from the printing apparatus 101 a notification that printing is interrupted, it executes again the processing in step S704 through step S708. The CPU 110 updates the print setting information by setting, as an output destination paper feed unit, the paper feed unit 140 selected based on the remaining paper width 304 subject to “roll auto” assignment. With the updated print settings, the CPU 110 performs retransmission of the print job of the print target page currently interrupted in the printing apparatus 101, and transmission of a print job of remaining print target pages.

Note that when the CPU 110 receives from the printing apparatus 101 a notification that printing is interrupted, it may display on the main screen 200 an interface capable of accepting a user selection of whether to continue printing. When the CPU 110 accepts a user selection for continuing printing, it may execute again the processing in step S704 through step S708. When the CPU 110 receives from the printing apparatus 101 a notification that printing is interrupted, it may display on the main screen 200 a message that prompts the user to mount paper in the paper feed unit 140 of the printing apparatus 101.

As described above, according to this embodiment, the CPU 110 executes the processing in FIGS. 7A and 7B in accordance with the printing application. If it is set to delete the margin of a print target page (YES in step S709), the CPU 110 performs processing of deleting the margin of the print target page in step S710 to step S713. Before the processing of deleting the margin of the print target page, the CPU 110 controls in step S706 selection of the paper feed unit 140 for which the difference between the size of the paper and that of the print target page satisfies the first condition. In this manner, selection of the paper feed unit 140 is performed before margin deletion processing in this embodiment, and it is possible to prevent printing in a state in which part of the print target page is lost.

According to this embodiment, when the margin deletion setting is ON, a print area obtained by excluding a margin from a page of interest is arranged as a rendering area on a print page for a page subjected to margin deletion. Further, when paper is further saved by rotating the rendering area, the rendering area is rotated and then arranged on the print page. Hence, printing can be executed efficiently.

Note that the CPU 110 obtains size information of the first page in step S703 in this embodiment, but the present disclosure is not limited to this. For example, a print target page included in a print target file is sometimes data of one page. When the print target page is one page, the margin deletion setting is ON, and the page is subjected to margin deletion, the CPU 110 may obtain the size of a print area within the print target page in step S703. In step S704, the CPU 110 may compare the size information of the print area obtained in step S703 with size information of paper obtained in step S702. If there is paper of a width larger than the obtained size (width or height) of the print area as a result of the comparison, the print target page is not printed in a state in which part of it is lost. Thus, paper can be saved, compared to a case where the size of the first page is obtained. That is, in the processing of FIGS. 7A and 7B, when a print target page included in a print target file is one page, the CPU 110 may select the paper feed unit 140 based on the print area. Also, when a print target file includes a plurality of print target pages, the CPU 110 may switch to select the paper feed unit 140 based on size information of the first page.

### Second Embodiment

The present disclosure is not limited to the above-described embodiment. For example, the first embodiment has described an example in which the output destination paper feed unit 140 is selected based on the size of the first page of a print target file. However, for example, there may be a paper feed unit 140 holding paper of a width larger than the sizes of the print areas of all pages of a print target file other than the first page and smaller than the size of the first page. In such a case, the paper feed unit 140 holding paper of a size capable of further reducing a margin in printing can be selected as the output destination paper feed unit 140, instead of selecting the output destination paper feed unit 140 based on the size of the first page. However, the processing may take time in comparison with a case where the paper feed unit 140 is selected based on the size of the first page, because it is necessary to obtain in advance information representing the sizes of the print areas of all pages, and compare the size of each page with each of the feed paper widths.

In a second embodiment, a CPU 110 first performs the processing in step S700 through step S708 of FIG. 7A. That is, the CPU 110 selects a paper feed unit 140 serving as an output destination based on the size of the first page. Then, the CPU 110 performs a process in step S709, and if it determines that the margin deletion setting is ON, performs the processing in step S710 through step S716 for each print target page. Note that in this embodiment, the CPU 110 temporarily stores the size of a specified print area in a memory such as a ROM 111 in step S712. In this embodiment, at the end of the processing in step S710 through step S716 for each print target page, the CPU 110 performs a preview display of the print target page.

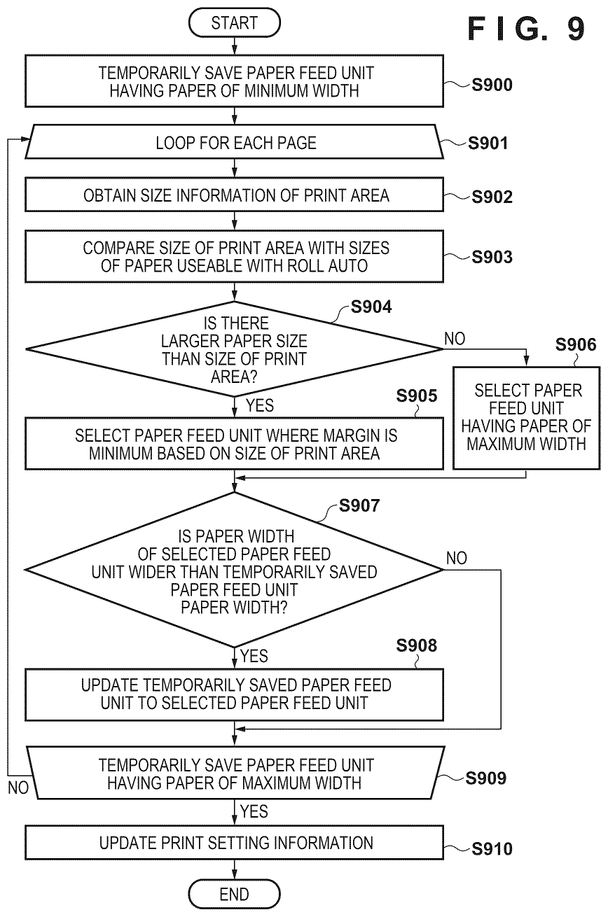

In this embodiment, when the processing in step S710 through step S716 end for all print target pages, the CPU 110 starts processing in FIG. 9. That is, when the print areas of all the print target pages are obtained, the processing in FIG. 9 starts.

FIG. 9 is a flowchart showing an example of processing executed by the CPU 110. In the processing of FIG. 9, the CPU 110 performs processing of selecting the paper feed unit 140 based on the size of a print area and that of paper mounted in the paper feed unit 140. Note that the processing in FIG. 9 is implemented by, for example, the CPU 110 deploying in a RAM 112 a printing application program stored in the memory such as the ROM 111, and executing it.

In step S900, the CPU 110 temporarily saves, in the ROM 111 or the RAM 112, the paper feed unit 140 holding paper of a minimum width among the paper feed units 140 subject to “roll auto” assignment. The processing in step S901 through step S909 is repeated for each print target page included in a print target file.

In step S902, the CPU 110 obtains the size of a print area by referring to the ROM 111 or the RAM 112.

In step S903, the CPU 110 compares the obtained size (width and height) of the print area with the size of the paper mounted in each of the paper feed units 140.

In step S904, the CPU 110 determines, with reference to the comparison result in step S903, whether there is paper of a size larger than the size (width or height) of the print area obtained in step S902. If the CPU 110 determines that there is paper of a larger size, it advances to step S905. If the CPU 110 determines that there is no paper of a larger size, it advances to step S906.

More specifically, in step S904, the CPU 110 determines whether the width of the paper is larger than the width or height of the print area. That is, the CPU 110 determines whether there is a paper feed unit 140 holding paper in which the print area fits in a case where the print area is not rotated or in a case where it is rotated by 90°. Note that in step S904, when it is set within the rotation designation portion 208 not to rotate the print area, the CPU 110 determines whether the width of the paper is larger than that of the print area.

If there are paper feed units 140 each holding paper of a width at which a print target page can be printed without any loss, the CPU 110 selects in step S905, from among the paper feed units 140, the paper feed unit 140 holding paper of a width at which the margin of a printed product becomes minimum.

That is, in step S905, the CPU 110 selects the paper feed unit 140 holding paper for which the difference between the size of the paper mounted in each paper feed unit 140 and that of the print area satisfies a second condition. The second condition includes a condition that the size of the paper is larger than that of the print area, and the difference between the size of the print area and that of the print target page is minimum. By selecting the paper feed unit 140 holding paper that satisfies the second condition, the print target page can be printed without any loss and without generating an unnecessary margin of a printed product.

In step S906, print data is lost regardless of which paper feed unit 140 is selected, so the CPU 110 selects the paper feed unit 140 holding paper of a maximum size (width) so as to minimize the amount of loss.

In step S907, the CPU 110 compares the size (width) of the paper selected in step S905 or step S906 with the minimum size of the paper of the paper feed unit temporarily saved in step S900. Then, the CPU 110 determines whether the paper size 304 of the paper feed unit 140 selected in step S905 or step S906 are larger than the paper size of the paper feed unit 140 temporarily saved in memory such as the RAM 112 in step S900. If the CPU 110 determines that the paper size 304 of the paper feed unit 140 selected in step S905 or step S906 are larger, it advances to step S908. If the CPU 110 determines that the paper size 304 of the paper feed unit 140 selected in step S905 or step S906 are not larger, it advances to step S909.

In step S908, the CPU 110 looks up a paper feed unit list to obtain the paper feed unit 140 coincident with the paper size and paper type of the paper feed unit 140 selected in step S905 or step S906. The CPU 110 updates the paper feed unit temporarily saved in memory such as the RAM 112 to the paper feed unit 140 obtained by this processing.

In step S909 at the end of repetition of the processing for each page, the CPU 110 determines whether the paper feed unit 140 holding paper of a maximum size among the paper feed units 140 subject to “roll auto” assignment has temporarily been saved in memory such as the RAM 112. If the CPU 110 determines that the paper feed unit 140 has temporarily been saved, it advances to step S910. In contrast, if the CPU 110 determines that the paper feed unit 140 has not temporarily been saved, it returns to step S901.

In step S910, the CPU 110 updates the print setting information by setting the paper feed unit 140 temporarily saved in memory such as the RAM 112 as the paper feed unit 140 to be used in printing.

Note that in step S910, if the print setting information is updated during preview display, the CPU 110 displays a message on a main screen 200 via an interface capable of accepting a user selection of whether to set the paper feed unit 140 updated in step S910 as the paper feed unit 140 to be used in printing. That is, in step S910, the CPU 110 accepts a user selection of whether to switch the paper feed unit 140 to be used in printing from the paper feed unit 140 selected by the processing in FIGS. 7A and 7B to the paper feed unit 140 updated in step S910. When switching of the paper feed unit is selected, the CPU 110 updates a preview image displayed within the preview display portion 202 in accordance with print settings determined by the sequence of FIG. 9. Note that when the paper feed unit 140 selected in the processing of FIGS. 7A and 7B and the paper feed unit 140 updated in step S910 are the same, the paper feed unit 140 need not be switched, and no user selection is accepted on the main screen 200.

In some cases, printing may be started without a preview display in shortcut printing, hot folder printing, or the like. That is, when part of a print job has already been transmitted to the printing apparatus 101, the CPU 110 transmits the remaining print job with print settings determined by the sequence of FIG. 9.

Note that switching of the physical paper feed unit during preview display may be selected by the user on a UI exemplified in FIG. 2A, or the physical paper feed unit may be switched automatically. The printing application may provide a setting value capable of selecting whether to select the switching by the user or automatically switch the physical paper feed unit.

As described above, according to this embodiment, there may be a paper feed unit 140 holding paper of a size larger than the sizes of the print areas of all print target pages of a print target file other than the first page and smaller than the size of the first page. In such a case, the paper feed unit 140 holding paper of a smaller width can be selected as an output destination paper feed unit, instead of selecting the output destination paper feed unit 140 based on the size of the first page. This can further save paper because a margin in a printed product can be deleted in comparison with selecting the output destination paper feed unit 140 based on the size of the first page.

By selecting the output destination paper feed unit 140 based on the size of the first page by the processing in FIGS. 7A and 7B before the processing in FIG. 9, a preview display and part of a print job can be transmitted to the printing apparatus 101 without keeping the user waiting.

A form is also possible in which a user selection of which of the paper feed unit 140 selected based on the size of the first page according to the first embodiment, and the paper feed unit 140 selected based on the size of a print area according to the second embodiment is set as the output destination paper feed unit 140 can be accepted on an acceptance screen of the main screen 200. The paper feed unit 140 selected by the user may be set as the output destination paper feed unit 140.

A form is also possible in which a user selection of whether to execute the processing (processing in FIG. 9) of selecting the output destination paper feed unit 140 based on the size of a print area according to the second embodiment can be accepted on the acceptance screen of the main screen 200. When a user selection for executing the processing in FIG. 9 is accepted, the processing in FIG. 9 may be executed.

A form is also possible in which the processing (processing in FIG. 9) of selecting the output destination paper feed unit 140 based on the size of a print area according to the second embodiment is executed when a print target page included in a print target file is data of one page.

According to the present disclosure, when a printing apparatus including a plurality of paper feed units is used, and when margin deletion processing is performed on print data, a proper paper feed unit can be selected.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-213837, filed Dec. 6, 2024, the entirety of which is incorporated herein by reference.

What is claimed is:

1. A non-transitory computer-readable storage medium storing a program configured to cause a computer of an information processing apparatus to function as:
a first obtaining unit configured to obtain first information representing a size of a printing medium mounted in each of a plurality of paper feed units in a printing apparatus capable of feeding paper from the plurality of paper feed units;
a second obtaining unit configured to obtain second information representing a size of a print target page included in print data for causing the printing apparatus to execute printing;
a first selection unit configured to select from among the plurality of paper feed units, based on the first information obtained by the first obtaining unit and the second information obtained by the second obtaining unit, a paper feed unit holding a printing medium for which a difference between the size of the printing medium and the size of the print target page satisfies a first condition; and
a control unit configured to, in a case where deletion of a margin of the print target page is set, execute control to perform selection of the paper feed unit by the first selection unit before processing of deleting the margin of the print target page.

2. The medium according to claim 1, wherein the first condition includes a condition that the size of the printing medium is larger than the size of the print target page.

3. The medium according to claim 2, wherein the first condition includes a condition that the difference between the size of the printing medium and the size of the print target page is minimum.

4. The medium according to claim 1, wherein the first information includes information representing a width of the printing medium mounted in each of the plurality of paper feed units of the printing apparatus, and the second information includes information representing a width of the print target page.

5. The medium according to claim 1, wherein the print target page is one of a plurality of print target pages of a print target file and, in a case where sizes of all print target pages of the print target file are equal, the first selection unit selects a paper feed unit holding a printing medium for which the difference between the size of the printing medium and the size of the print target pages satisfies the first condition.

6. The medium according to claim 1, wherein the program causes the computer to further function as a first setting unit configured to set the paper feed unit selected by the first selection unit as a paper feed unit to be used for printing the print data.

7. The medium according to claim 1, wherein the program causes the computer to further function as:
a specifying unit configured to specify a size of a print area within the print target page; and
a second selection unit configured to select from among the plurality of paper feed units, based on the first information obtained by the first obtaining unit and the size of the print area specified by the specifying unit, a paper feed unit holding a printing medium for which a difference between the size of the printing medium and the size of the print area within the print target page satisfies a second condition.

8. The medium according to claim 7, wherein the second condition includes a condition that the size of the printing medium is larger than the size of the print area, and the difference between the size of the print area and the size of the printing medium is minimum.

9. The medium according to claim 7, wherein the program causes the computer to further function as a first acceptance unit configured to accept a first user operation for executing selection of the paper feed unit by the second selection unit, and
in a case where the first user operation is accepted by the first acceptance unit, the control unit executes control to perform selection of the paper feed unit by the second selection unit.

10. The medium according to claim 7, wherein, in the case where deletion of a margin of the print target page is set, the control unit executes control to perform selection of the paper feed unit by the second selection unit after processing of deleting the margin of the print target page.

11. The medium according to claim 7, wherein the control unit executes control to perform selection of the paper feed unit by the second selection unit in a case where the print target page included in the print data is data of one page.

12. The medium according to claim 7, wherein the program causes the computer to further function as a second setting unit configured to set the paper feed unit selected by the second selection unit as a paper feed unit to be used for printing the print data.

13. The medium according to claim 12, wherein the program causes the computer to further function as a second acceptance unit configured to accept a second user operation of whether to set, by the second setting unit, the paper feed unit selected by the second selection unit as the paper feed unit to be used for printing the print data.

14. An information processing apparatus comprising at least one processor and at least one memory storing a program which, when executed by the at least one processor, causes the at least one processor to function as:
a first obtaining unit configured to obtain first information representing a size of a printing medium mounted in each of a plurality of paper feed units in a printing apparatus capable of feeding paper from the plurality of paper feed units;
a second obtaining unit configured to obtain second information representing a size of a print target page included in print data for causing the printing apparatus to execute printing;
a first selection unit configured to select from among the plurality of paper feed units, based on the first information obtained by the first obtaining unit and the second information obtained by the second obtaining unit, a paper feed unit holding a printing medium for which a difference between the size of the printing medium and the size of the print target page satisfies a first condition; and
a control unit configured to, in a case where deletion of a margin of the print target page is set, execute control to perform selection of the paper feed unit by the first selection unit before processing of deleting the margin of the print target page.

15. A method of controlling an information processing apparatus, comprising:
obtaining first information representing a size of a printing medium mounted in each of a plurality of paper feed units in a printing apparatus capable of feeding paper from the plurality of paper feed units;
obtaining second information representing a size of a print target page included in print data for causing the printing apparatus to execute printing;
selecting from among the plurality of paper feed units, based on the obtained first information and the obtained second information, a paper feed unit holding a printing medium for which a difference between the size of the printing medium and the size of the print target page satisfies a first condition; and
in a case where deletion of a margin of the print target page is set, executing control to perform selection of the paper feed unit before processing of deleting the margin of the print target page.
